(19) United States
(12) Patent Application Publication
(10) Pub. No.: US 2025/0217521 A1
(43) Pub. Date: Jul. 3, 2025

(54) DETECTION OF AND RESPONSE TO TAMPER EVENTS

(71) Applicant: Texas Instruments Incorporated, Dallas, TX (US)

(72) Inventors: Veeramanikandan Raju, Bangalore (IN); Anand Kumar G, Bengaluru (IN)

(21) Appl. No.: 18/402,417

(22) Filed: Jan. 2, 2024

(51) Int. Cl. G06F 21/81

(52) U.S. Cl. CPC G06F 21/81

(57) ABSTRACT

Methods, apparatus, systems, and articles of manufacture are described to protect against tamper events. An example method includes in response to a detected tamper event, at least one of (a) causing a programmable circuitry to enter standby mode or (b) causing adjustment of firewall settings to prevent access to a sub-system; generating a number; and causing the programmable circuitry to at least one of (a) exit the standby mode or (b) return the firewall settings to allow access to the sub-system after a threshold amount of time, the threshold amount of time corresponding to the generated number.

### RELATED APPLICATIONS

The present application is related to commonly assigned U.S. patent application Ser. No. 18/309,340, titled “VOLTAGE GLITCH DETECTOR,” filed on Apr. 28, 2023, and U.S. patent application Ser. No. 18/375,732, entitled “METHODS AND APPARATUS TO PROTECT AGAINST VOLTAGE GLITCH ATTACKS IN MICROCONTROLLERS,” filed on Oct. 2, 2023. U.S. patent application Ser. Nos. 18/309,340 and 18/375,732 are hereby incorporated herein by reference in their entireties.

### TECHNICAL FIELD

This description relates generally to circuits, and, more particularly, to methods and apparatus to protect against tamper events in circuits such as microcontrollers.

### BACKGROUND

Microcontrollers and/or other computing devices include processing circuitry (e.g., central processing units, graphics processing units, and/or any other type of processing units) that performs one or more operations to structure and/or secure the components of the microcontroller during startup and/or initialization. For example, while processing circuitry starts up, boots, and/or initializes, the processing circuitry uses the clock signal for basic timing and control to execute the instructions needed to startup, boot, and/or initialize. Some microcontrollers include tamper detection circuitry to detect abnormalities in the microcontroller that may correspond to a tamper event and/or attack.

### SUMMARY

An example of the description includes a method which includes in response to a detected tamper event, at least one of (a) causing a programmable circuitry to enter standby mode or (b) causing adjustment of firewall settings to prevent access to a sub-system; generating a number; and causing the programmable circuitry to at least one of (a) exit the standby mode or (b) return the firewall settings to allow access to the sub-system after a threshold amount of time, the threshold amount of time corresponding to the generated number.

### BRIEF DESCRIPTION OF THE DRAWINGS

FIG. 1 is an example circuit described in conjunction with examples described herein.

FIG. 2 is a block diagram of an example of full tamper detection circuitry of FIG. 1.

FIG. 3 is a block diagram of an example of response and recovery circuitry of an example leader controller of FIG. 1.

FIG. 4 is a block diagram of an example of response and recovery circuitry of an example follower system on a chip of FIG. 1.

FIG. 5 is a block diagram of an example of voltage recovery circuitry of FIG. 3.

FIG. 6 is a block diagram of an example of voltage recovery circuitry of FIG. 4.

FIG. 7 is timing diagram described in conjunction with the circuit of FIG. 1.

FIG. 8 is a flowchart representative of a method and/or operations that may be executed to implement the response and recovery circuitry of FIGS. 1-6.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Microcontrollers and/or other controllers are implemented in a variety of electronics to perform operations and/or tasks. Such controllers include processing circuitry (e.g., CPU(s), a GPU(s), etc.) to facilitate the execution of instructions to perform the operations and/or tasks in conjunction with other peripheral devices (e.g., sensors, motors, keyboards, user interfaces, etc.). The processing circuitry utilizes a clock signal to execute the instructions. Accordingly, microcontrollers include and/or are connected to one or more clock oscillators that generate the clock signal(s) that the processing circuitry uses to execute the instructions. A power source (e.g., a battery, a plug, etc.) is connected to a terminal of the microcontroller (e.g., a VDD terminal, a digital logic VDD (VDDD) terminal, etc.) to provide power to the components of the microcontroller.

During startup, boot, reboot, initialization, etc., the processing circuitry of a microcontroller executes various instructions to prepare for operation. Such instructions may cause one or more values in registers of the microcontroller to be set to operate different configurations. Such instructions may correspond to the initialization of security protocols to protect the microcontroller from attacks such as unintended debug settings or denial of service attacks.

Some attackers may attempt to corrupt the information in a circuit, such as a microcontroller, by applying a voltage glitch, a clock glitch, electromagnetic injection, a laser-based glitch, etc. For example, during startup, an attacker may apply a voltage glitch to the supply voltage terminal to decrease the supply voltage. Responsive to the supply voltage dropping, the processing circuitry may unintentionally skip one or more operations. Thus, an attacker can apply a voltage glitch during startup to attempt to make the processing circuitry to skip security protocols and/or debug configurations during startup and then take advantage/exploit of the security loopholes created by the voltage glitch during startup. Likewise, attacks to a clock signal, application of high or low temperatures, injection of electromagnetic signals, introduction of a laser, etc. can cause the processing circuitry to skip security protocols and/or debug configurations during startup, allowing an attacker to take advantage/exploit security loopholes created by such attacks.

Tamper detection circuitry (e.g., voltage glitch detection circuitry, clock loss detection circuitry, temperature sensors, etc.) can be implemented in a microcontroller to identify a tamper event corresponding to an attack and/or abnormalities. Responsive to the tamper detection circuitry detecting one or more tamper events (e.g., a voltage glitch, clock loss, particular temperatures, etc.), The tamper detection circuitry outputs one or more signals (e.g., one or more high voltages) to indicate that one or more attacks may be occurring.

Some microcontrollers use the tamper event indication signal to reset the processing circuitry. Resetting the processing circuitry clears the information that the processing circuitry structured up to the point where the tamper event occurs and restarts the startup, boot, initialization process from the beginning. Although resetting the processing circuitry protects against an attack, the reset processing takes time and/or resources to redo the instructions performed before the tamper event. Accordingly, resetting the processing circuitry in response to a tamper event indication (also referred to as an abnormality event) can lead to latency and/or power consumption overhead.

Examples described herein utilize logic circuitry to protect a circuits from tamper events without the latency and/or power overhead associated with resetting the processing circuitry. Examples described herein utilize circuitry to halt operations of the processing circuitry (e.g., by causing the processing circuitry to enter standby mode). As used herein, standby mode may include a sleep mode, a low-power mode, and/or any mode different than a normal operating mode. Also, examples described herein may, in response to detecting a tamper event, adjust firewall settings to prevent access and/or change to a sub-component (e.g., memory, accelerators, etc.) of the system. Using examples described herein, electronic devices such as microcontrollers can protect against tamper events in a fast and efficient manner.

Examples described herein further include exiting standby mode in different ways. For example, after tamper detection circuitry determines that a tamper event has ended, examples described herein may include circuitry configurable to generate a random number and wait for a duration of time corresponding to the random number until unpausing the processing circuitry (e.g., exiting the standby mode and/or returning the firewall settings to the settings before the tamper event was identified). Randomizing the time to exit standby mode after a tamper event provides extra security from the attacker. For example, if the attacker attempts to apply multiple glitches, the attacker will not be able predict the timing of the glitch protection protocol if the timing is different for each detected glitch. Also or alternatively, examples described herein may, after a random duration of time, exit the standby mode without waiting until the tamper event has ended. Also or alternatively, examples described herein may exit a standby mode in response to instructions from a leader controller.

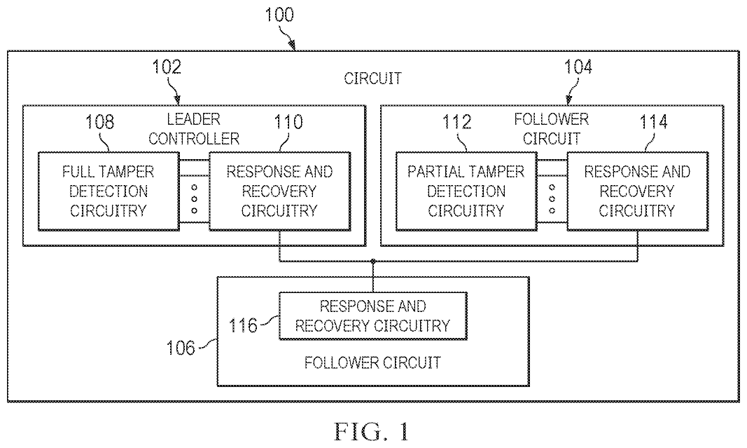

FIG. 1 illustrates an example circuit 100. However, the circuit 100 may be another controller device, including any semiconductor device or integrated circuit such as a power management integrated circuit. The example circuit 100 includes an example leader controller 102 and example follower circuits 104 and 106. The leader controller 102 includes example full tamper detection circuitry 108 and example response and recovery circuitry 110. The follower circuit 104 includes partial tamper detection circuitry 112 and example response and recovery circuitry 114. The follower circuit 106 includes example response and recovery circuitry 116. Although the circuit 100 includes a single leader controller and two follower SoCs, the circuit 100 may include any number of leader controllers, follower SoCs (e.g., with full tamper detection circuitry, partial tamper detection circuitry, and/or no tamper detection circuitry). Although, the example leader controller 102 and the follower circuits 104, 106 are implemented within the same circuit 100, the leader controller 102, the follower circuitry 104, and/or 106 may be implemented in different circuits, boards, chips, etc.

The circuits 104 and 106 are herein referred to as follower systems on chips (SOCs). However, the circuits 104 and 106 may be any type of circuits that are coupled to the leader controller 102. For example, circuits 104 and 106 may be implemented as integrated circuits, processing circuits, logic circuits, and/or semiconductor dies that are coupled to the leader controller 102. In some examples, circuits 104 and/or 106 are not part of the same circuit 100 as the leader controller 102. For example, circuits 104 and 106 may be circuits that are part of the system and/or mounted to the same circuit board as the leader controller 102.

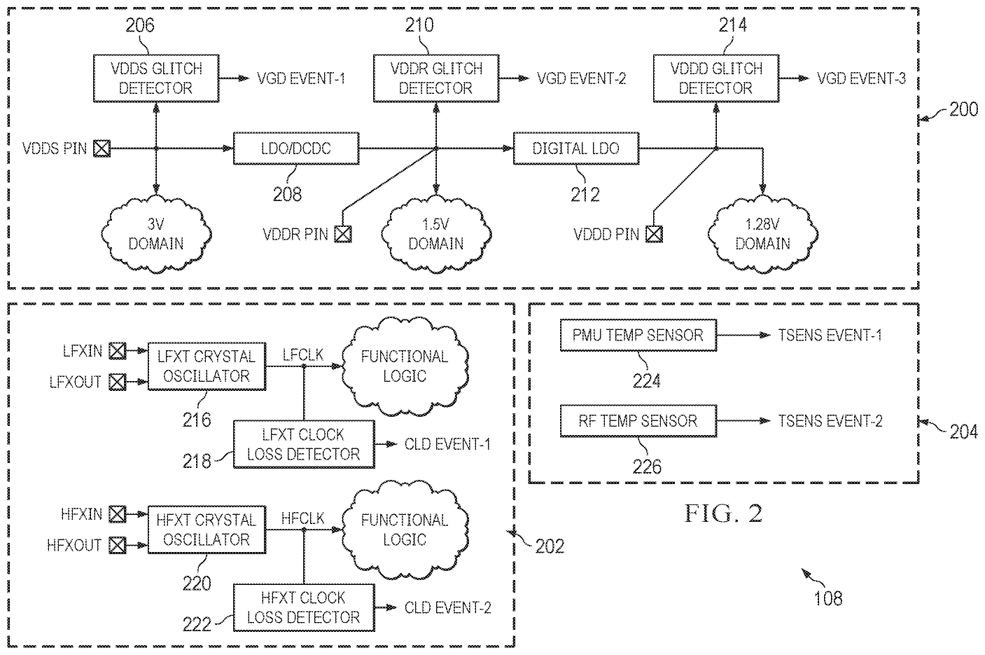

The leader controller 102 of FIG. 1 includes processing circuitry to perform operations and/or execute instructions for the example circuit 100. The leader controller 102 is a leader because the leader controller 102 can, based on an output signal from the response and recovery circuitry 110, output an IO event signal to cause one or more of the follower circuits 104, 106 to enter into a standby mode and/or block access and/or control of one or more subcomponents of the respective circuits 104, 106. For example, the IO event signal output by the leader controller 102 can cause one or more of the follower circuits 104, 106 to enter and/or exit standby mode, as further described below. The leader controller 102 includes full tamper detection circuitry 108 to identify a plurality of tamper events (e.g., voltage glitches, clock loss, temperature events, electromagnetic events, laser events, etc.). In some examples, the full tamper detection circuitry 108 is located outside of the leader controller 102 and/or the circuit 100. In such examples, the outputs of the full tamper detection circuitry 108 can be provided to the response and recovery circuitry 110 of the leader controller 102 via a wired or wireless connection. An example implementation of the full tamper detection circuitry 108 is further described below in conjunction with FIG. 2.

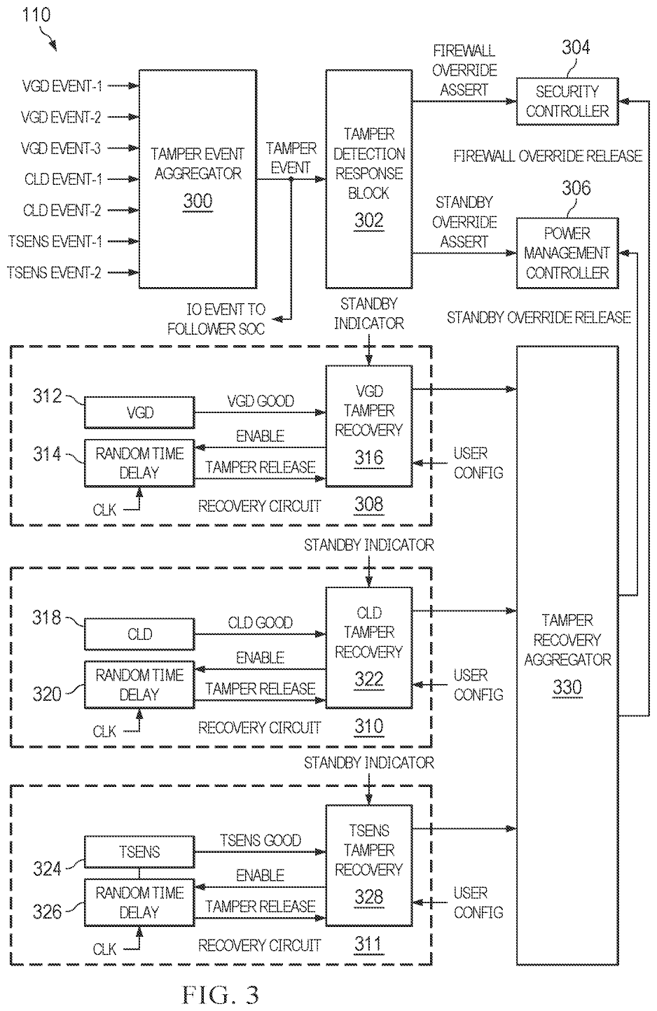

The leader controller 102 of FIG. 1 includes the example response and recovery circuitry 110 to respond and recover to an identified tamper event from the full tamper detection circuitry 108. For example, the response and recovery circuitry 110 can cause the processing circuitry of the leader controller 102 to enter into a standby mode after the full tamper detection circuitry 108 detects a tamper event. Also, the response and recovery circuitry 110 can cause firewall settings to be adjusted to restrict or block access to one or more sub-components of the leader controller 102. Also, the response and recovery circuitry 110 can, using an IO event signal, trigger the response and recovery circuitry 114, 116 of one or more of the follower circuits 104, 106 switch operation of the processor circuitry of the one or more follower circuits 104, 106 to enter a standby mode and/or adjust firewall settings to block access to one or more sub-components of the respective follower circuits 104, 106. Also, the response and recovery circuitry 110 can, using the IO event signal, recover from the standby mode and/or secure firewall settings to return to normal operation of the leader controller 102. In some examples, the response and recovery circuitry 110 can, using the IO event signal, trigger the response and recovery circuitry 114, 116 of the one or more of the follower circuits 104, 106 to reset/recover from standby mode and/or secure firewall settings to return to normal operation of the respective follower circuit 104, 106. The response and recovery circuitry 110 is further described below in conjunction with FIG. 3.

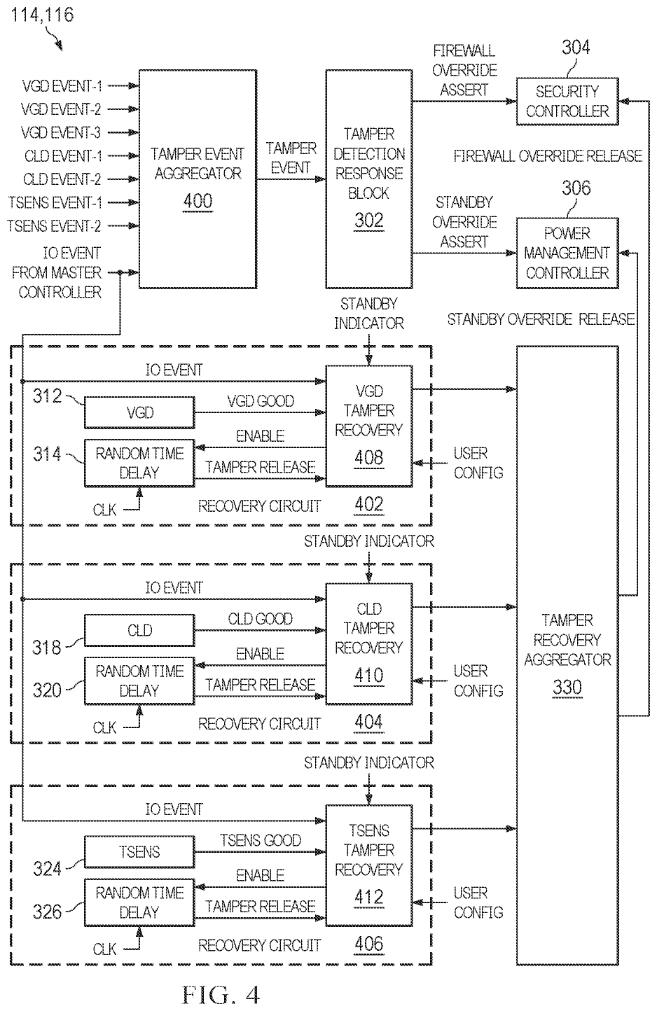

The follower circuit 104 of FIG. 1 is a follower circuit 104 that may respond to a tamper event and/or recovery from standby mode and/or secure firewall settings based on information from the partial tamper detection circuitry 112 and/or based on a trigger (e.g., included in the IO event signal) from the response and recovery circuitry 110 of the leader controller 102. For example, the follower circuit 104 includes partial tamper detection circuitry 112 which can track some tamper events that may occur at or near the follower circuit 104 but not all of the tamper events that are tracked by the full tamper detection circuitry 108. Thus, the response and recovery circuitry 114 causes processor circuitry of the follower circuit 104 to enter a standby mode and/or adjust firewall settings for sub-components of the follower circuit 104 based on information from the partial tamper detection circuitry 112 and/or from the response and recovery circuitry 110 of the leader controller 102 (e.g., based on the IO event signal). Also, the response and recovery circuitry 114 cause processor circuitry of the follower circuit 104 to exit a standby mode and/or return the firewall settings for sub-components of the follower circuit 104 to return to normal operation based on information from the partial tamper detection circuitry 112 and/or from the response and recovery circuitry 110 of the leader controller 102 (e.g., using the IO event signal). In some examples, the full tamper detection circuitry 112 is located outside of the circuit 104 and/or the circuit 100. In such examples, the outputs of the full tamper detection circuitry 112 can be provided, using the IO event signal, to the response and recovery circuitry 114 of the circuit 104 via a wired or wireless connection. The response and recovery circuitry 114 is further described below in conjunction with FIG. 4.

The follower circuit 106 of FIG. 1 is a follower circuit 106 that may respond to a tamper event and/or recovery from standby model and/or secure firewall settings based on a trigger from the response and recovery circuitry 110 of the leader controller 102. For example, the follower circuit 106 does not include any tamper detection circuitry. Thus, the response and recovery circuitry 116 causes processor circuitry of the follower circuit 106 to enter a standby mode and/or adjust firewall settings for sub-components of the follower circuit 106 based on information from the response and recovery circuitry 110 of the leader controller 102 using the IO event signal. For example, as further described below, the response and recovery circuitry 110 of the leader controller 102 tracks the tamper events and outputs an IO event signal to the follower circuitry 106 based on a detected tamper event to cause the follower circuitry 106 to enter into standby mode and/or adjust firewall settings. Also, the response and recovery circuitry 116 cause processor circuitry of the follower circuit 106 to exit a standby mode and/or return the firewall settings for sub-components of the follower circuit 106 to return to normal operation based on the IO event signal from the response and recovery circuitry 110 of the leader controller 102. Thus, the leader controller 102 can use the IO event signal to cause the follower circuit(S) 104, 106 to enter standby mode, adjust firewall settings, and/or exit standby mode based on tamper event detected by the leader controller 102. The response and recovery circuitry 116 is further described below in conjunction with FIG. 5.

In some examples, a follower circuit is a circuit that lacks some or all of the capability of detecting a tamper event and/or determining whether to resume normal operation after the detection of a tamper event. A follower circuit (e.g., circuits 104, 106) may have partial or no ability to detect a tamper event, while the leader controller 102 may have greater capability to detect a tamper event than the follower circuit. To allow for a follower circuit to respond to a tamper event, the leader controller 102 can signal to the follower circuit to enter and exit standby mode, for example. To communicate with the follower circuit, the leader controller 102 can use the IO event signal shown in FIGS. 3, 4, 6, and 7. In this way, the follower SoC can have the security features of responding and recovering from a tamper event without the full circuitry of the leader controller 102. In some examples, the follower circuit may have full ability to detect a tamper event, but the follower circuit may be configurable to follow the IO event signal received from the leader controller 102.

FIG. 2 is a block diagram of the example full tamper detection circuitry 108 of FIG. 1. The full tamper detection circuitry 108 includes example voltage glitch detection circuitry 200, example clock event detection circuitry 202, and example temperature event detection circuitry 204. In some examples, the full tamper detection circuitry 108 may include other event detection circuitry (e.g., electromagnetic event detection circuitry, laser-based even detection circuitry, etc.). The voltage glitch detection circuitry 200 includes main supply voltage (VDDS) glitch detection circuitry 206, a low drop out regulator (LDO) 208, regulated supply voltage (VDDR) glitch detection circuitry 210, a digital LDO 212, and VDDD glitch detection circuitry 214. The clock event detection circuitry 202 includes example oscillators 216, 220 (e.g., crystal oscillators), and example clock loss detection circuitries 218, 222. The example temperature event detection circuitry 204 includes example sensors 224, 226. The example partial tamper detection circuitry 112 may include a subset of the components of the full tamper detection circuitry 108 of FIG. 2 and/or different components from the full tamper detection circuitry 108.

The voltage glitch detection circuitry 200 of FIG. 2 can identify one or more voltage glitches at one or more voltage domains or voltage rails of the implementing circuitry. In the example of FIG. 2 the supply voltage is obtained from the VDDS pin at the 3 Volt (V) domain, the VDDR voltage is obtained from the output of the LDO 208 and/or the VDDR pin at the 1.5 V domain, and the VDDD voltage is obtained from the output of the digital LDO 212 and/or the VDDD pin at the 1.28 V domain. However, the domains may correspond to different voltage levels. The VDDS glitch detection circuitry 206 of FIG. 1 is circuitry that detects a voltage glitch on at the 3 V domain. For example, the VDDS glitch detection circuitry 206 can detect a voltage glitch at the VDDS terminal of the leader controller 102. As described above, a voltage glitch (e.g., also referred to as a voltage undershoot or voltage overshoot) corresponds to a voltage at a terminal or node dropping below or raising above an intended value. Accordingly, the VDDS glitch detection circuitry 206 determines whether the voltage at the terminal or node is below or above a threshold. In some examples, the VDDS glitch detection circuitry 206 also or alternatively identifies a voltage glitch based on the slope and/or width of the voltage glitch. During the voltage glitch, the VDDS glitch detection circuitry 206 outputs a signal indicative of the voltage glitch (e.g., a voltage glitch event). For example, responsive to there being no voltage glitch, the VDDS glitch detection circuitry 206 may output a first voltage (e.g., 0 Volts (V) or a logic low). Responsive to there being a voltage glitch, the VDDS glitch detection circuitry 206 may output a second voltage (e.g., 1.3 V or a logic high). The output of the VDDS glitch detection circuitry 206 is output to response and recovery circuitry 110, as further described below in conjunction with FIG. 3. The LDO 208, which may be replaced with a direct current (DC)-to-DC converter, adjusts the 3 V input supply voltage to a 1.5 V supply voltage for the 1.5 V domain.

The VDDR Glitch detection circuitry 210 of FIG. 2 is circuitry that detects a voltage glitch on at the 1.5 V domain. For example, the VDDR glitch detection circuitry 210 can detect a voltage glitch at the VDDR terminal of the leader controller 102. As described above, a voltage glitch (e.g., also referred to as a voltage undershoot or voltage overshoot) corresponds to a voltage at a terminal or node dropping below or raising above an intended value. Accordingly, the VDDR Glitch detection circuitry 210 determines whether the voltage at the terminal or node is below or above a threshold. In some examples, the VDDR Glitch detection circuitry 210 also or alternatively identifies a voltage glitch based on the slope and/or width of the voltage glitch. During the voltage glitch, the VDDR Glitch detection circuitry 210 outputs a signal indicative of the voltage glitch (e.g., a voltage glitch event). For example, responsive to there being no voltage glitch, the VDDR Glitch detection circuitry 210 may output a first voltage (e.g., 0 Volts (V) or a logic low). Responsive to their being a voltage glitch, the VDDR Glitch detection circuitry 210 may output a second voltage (e.g., 1.3 V or a logic high). The output of the VDDR Glitch detection circuitry 210 is output to response and recovery circuitry 110, as further described below in conjunction with FIG. 3. The digital LDO 212 adjusts the 1.5 V input supply voltage to a 1.28 V supply voltage for the 1.28 V domain.

The VDDD Glitch detection circuitry 214 of FIG. 2 is circuitry that detects a voltage glitch on at the 1.28 V domain. For example, the VDDD Glitch detection circuitry 214 can detect a voltage glitch at the VDDD terminal of the leader controller 102. As described above, a voltage glitch (e.g., also referred to as a voltage undershoot or voltage overshoot) corresponds to a voltage at a terminal or node dropping below or raising above an intended value. Accordingly, the VDDD Glitch detection circuitry 214 determines whether the voltage at the terminal or node is below or above a threshold. In some examples, the VDDD Glitch detection circuitry 214 also or alternatively identifies a voltage glitch based on the slope and/or width of the voltage glitch. During the voltage glitch, the VDDD Glitch detection circuitry 214 outputs a signal indicative of the voltage glitch (e.g., a voltage glitch event). For example, if there is no voltage glitch, the VDDD Glitch detection circuitry 214 may output a first voltage (e.g., 0 Volts (V) or a logic low). If there is a voltage glitch, the VDDD Glitch detection circuitry 214 may output a second voltage (e.g., 1.3 V or a logic high). The output of the VDDD Glitch detection circuitry 214 is output to response and recovery circuitry 110, as further described below in conjunction with FIG. 3.

The clock event detection circuitry 202 includes the example oscillators 216, 220 and the clock loss detection circuitries 218, 222. The clock oscillators 216, 220 of FIG. 1 are devices to generate clock signals (e.g., clock signals with different frequencies). For example, the oscillators 216, 220 generate a periodic signal that the processing circuitry of the leader controller 102 can use to execute instructions. In some examples, the oscillators 216, 220 may be implemented outside of the leader controller 102 and the clock signals may be provided by the external clock oscillator via a terminal of the leader controller 102. In some examples, the functional logic sources the system clocks from a range of the clock oscillators 216, 220 and distribute the clock signals to other components of the leader controller 102. In some examples, the clock event detection circuitry 202 can track any number of oscillators.

The clock loss detection circuitries 218, 222 of FIG. 2 detect clock loss and/or any other abnormalities of the clock signals output by the respective oscillators 216, 220. For example, the clock loss detection circuitries 218, 222 can monitor the frequency of the clock signals output by the respective oscillators 216, 220 to determine if the frequency has increased, decreased, absent and/or includes any other abnormality. During the clock event (e.g., corresponding to clock loss and/or an abnormality), the corresponding clock loss detection circuitry 218, 222 outputs a signal indicative of the clock event. For example, if there is no clock event, the clock loss detection circuitry 218, 222 may output a first voltage (e.g., 0 Volts (V) or a logic low). If there is a clock event detected by the clock loss detection circuitry 218, for example, the clock loss detection circuitry 218 may output a second voltage (e.g., 1.3 V or a logic high). The output of the clock loss detection circuitries 218, 222 are output to response and recovery circuitry 110, as further described below in conjunction with FIG. 3.

The example temperature event detection circuitry 204 includes the example temperature sensors 224, 226. The first temperature sensor 224 senses temperatures near a power management unity (PMU) of the leader controller 102 and the second temperature sensor 226 senses temperatures near radio frequency RF circuitry of the leader controller 102. However, the temperature event detection circuitry 204 may include any number and/or type of temperature sensors. The sensors 224, 226 trigger a temperature event by outputting a signal indicative of the temperature event if the sensed temperature falls outside of a predefined range of temperature. For example, if the temperatures are within the respective temperature ranges, the sensors 224, 226 may output a first voltage (e.g., 0 Volts (V) or a logic low). If one or more of the temperatures are outside the respective temperature ranges, the corresponding one or more sensors 224, 226 may output a second voltage (e.g., 1.3 V or a logic high). The output of the sensors 224, 226 are output to response and recovery circuitry 110, as further described below in conjunction with FIG. 3.

FIG. 3 is a block diagram of an example implementation of the response and recovery circuitry 110 of FIG. 1. The example response and recovery circuitry 110 of FIG. 3 includes example tamper event aggregation circuitry 300, example tamper detection response circuitry 302, an example security controller 304, an example power management controller 306, example recovery circuitries 308, 310, 311, and an example tamper recovery aggregation circuitry 330. The first recovery circuitry 308 includes an example input terminal 312, example random time delay circuitry 314, and example voltage glitch recovery circuitry 316. The second recovery circuitry 310 includes an example input terminal 318, example random time delay circuitry 320, and example clock tamper event recovery circuitry 322. The third recovery circuitry 311 includes an example input terminal 324, example random time delay circuitry 326, and example temperature tamper event recovery circuitry 328.

The tamper event aggregation circuitry 300 of FIG. 3 aggregates the multiple outputs of the full tamper detection circuitry 108 of FIG. 2 to determine whether a tamper event has been detected from any one or more of the example voltage glitch detection circuitry 200, the example clock event detection circuitry 202, and the example temperature event detection circuitry 204 of FIG. 2. In some examples, the tamper event aggregation circuitry 300 may also include inputs for additional tamper event tracking circuitries (e.g., an electromagnetic event, a laser event, etc.). In some examples, the tamper event aggregation circuitry 300 may include external inputs of tamper event detection circuitry that is external to the leader controller 102 and/or the circuit 100 (e.g., connected via a wired or wireless connection). In some examples, the tamper event aggregation circuitry 300 includes and/or operates as a logic OR gate. For example, if all of the inputs correspond to a voltage that represents no tamper event, the tamper event aggregation circuitry 300 outputs a first voltage (e.g., a low voltage or 0 V) to indicate that there no tamper events have been detected. However, if any one or more of the inputs correspond to a voltage that represents a tamper event, the tamper event aggregator outputs a second (e.g., high) voltage to indicate that a tamper event has been detected. The output (e.g., the IO event terminal) of the tamper event aggregation circuitry 300 is input into the tamper detection response circuitry 302 and/or to the response and recovery circuitries 114, 116 of the follower circuits 104, 106, as further described below in conjunction with FIG. 4. For example, as further described below, the signal output by the tamper event aggregation circuitry 300, herein referred to as a tamper event signal or an IO event signal, can cause components of the leader controller 102 and/or components of the follower circuits 104, 106 to enter/exit into/from a standby mode and/or adjust firewall settings.

The tamper detection response circuitry 302 of FIG. 3 outputs a firewall override assertion signal and/or a standby override assertion signal in response to an indication of a tamper event (e.g., corresponding to an IO event signal/tamper event signal) from the tamper event aggregation circuitry 300. For example, the tamper detection response circuitry 302 can operate as a driver to, in response to a tamper event indication from the tamper event aggregation circuitry 300, drive the security controller 304 to adjust firewall settings and/or drive the power management controller 306 to switch the operation of the leader controller 102 to enter a standby mode.

The security controller 304 of FIG. 3 can adjust the firewall settings for different sub-components of the lead controller 102 in response to a firewall override assertion signal from the tamper detection response circuitry 302. For example, the security controller 304 can adjust the firewall settings to block access to accelerators, memory, debug systems, etc. Also, the security controller can reset the firewall settings (e.g., return the firewall settings to what they were prior to a detected tamper event) in response to a firewall override release signal from the tamper recovery aggregation circuitry 330. The override release signal and the tamper recovery aggregation circuitry 330 are further described below.

The power management controller 306 of FIG. 3 can cause the processing circuitry of the leader controller 102 to enter standby mode in response to a standby override assertion signal from the tamper detection response circuitry 302. Also, the security controller can cause the processing circuitry to exit the standby mode in response to a standby override release signal from the tamper recovery aggregation circuitry 330. The override release signal and the tamper recovery aggregation circuitry 330 are further described below.

The first recovery circuitry 308 of FIG. 3 facilitates the recovery from standby mode by determining whether to exit standby mode with respect to a voltage glitch. The input terminal 312 obtains a signal from the voltage glitch detection circuitry 200 of FIG. 2 if there is no indication of a voltage glitch (e.g., during regular operation and/or after a voltage glitch ends). For example, the input terminal 312 can be coupled to the output terminal of one or more of the VDDS glitch detection circuitry 206, the VDDR glitch detection circuitry 210, and/or the VDDD glitch detection circuitry 214 of FIG. 2. If all of the outputs of the respective circuitries 206, 210, 214 reflect that there is no voltage glitch, a VGD (voltage glitch detection) good signal will be input into the voltage glitch tamper recovery circuitry 316. In this manner, the voltage tamper recovery circuitry 316 can determine whether to exit standby mode based on a voltage glitch ending or not existing, as further described below.

The random time delay circuitry 314 of FIG. 3 generates a random, pseudo-random, quasi-random, and/or predefined delay based on a signal from the voltage glitch tamper recovery circuitry 316. As further described below, the voltage glitch tamper recovery circuitry 316 can use the random time delay to wait before outputting a signal to indicate that standby mode can be exited to provide additional security from an attacker. The random time delay circuitry 314 is further described below in conjunction with FIGS. 5 and/or 6. A random time delay (e.g., fully random, pseudo-random, or quasi-random) can allow for a circuit to avoid transitioning from standby mode into active mode after a fixed time interval. Transitioning back to active mode after a fixed time interval can provide a signature to an attacker. Using a variable/random time duration for the transition can prevent the attacker from predicting while the circuit will resume active mode.

The voltage glitch tamper recovery circuitry 316 of FIG. 3 determines whether to indicate that standby mode can be exited with respect to voltage glitch monitoring. For example, the voltage glitch tamper recovery circuitry 316 can determine, based on user and/or manufacturer preferences, that standby mode can be exited after a random amount of delay after determining that there is no or no longer a voltage glitch. Also, the voltage glitch tamper recovery circuitry 316 can determine, based on user and/or manufacturer preferences, that the standby mode can be exited after a random amount of delay after a standby indicator has been obtained. A standby indicator may be a signal from the processing circuitry that standby mode has been implemented. After the voltage glitch tamper recovery circuitry 316 determines that standby mode can be exited, the voltage glitch tamper recovery circuitry 316 outputs a signal to the tamper recover aggregation circuitry 330.

The second recovery circuitry 310 of FIG. 3 facilitates the recovery from standby mode by determining whether to exit standby mode with respect to clock loss. The input terminal 318 obtains a signal from the clock event detection circuitry 202 of FIG. 2 if there is no indication of a clock loss (e.g., during regular operation and/or after a clock loss ends). For example, the input terminal 318 can be coupled to the output terminal of one or more of clock loss detection circuitries 218, 222 of FIG. 2. If the outputs of the respective circuitries 218, 222 reflect that there is no clock loss, a CLD (clock loss detection) good signal will be input into the clock loss tamper recovery circuitry 322. In this manner, the clock loss tamper recovery circuitry 322 can determine whether the exit standby mode based on a clock loss ending or not existing, as further described below.

The random time delay circuitry 320 of FIG. 3 generates a random, pseudo-random, quasi-random, and/or predefined delay based on a signal from the clock loss tamper recovery circuitry 322. As further described below, the clock loss tamper recovery circuitry 322 can use the random time delay to wait before outputting a signal to indicate that standby mode can be exited to provide additional security from an attacker. The random time delay circuitry 320 is further described below in conjunction with FIGS. 5 and/or 6.

The clock loss detection tamper recover circuitry 322 of FIG. 3 determines whether to indicate that standby mode can be exited with respect to clock loss monitoring. For example, the clock loss detection tamper recovery circuitry 322 can determine, based on user and/or manufacturer preferences, that standby mode can be exited after a random amount of delay after determining that there is no or no longer a clock loss. Also, the clock loss detection tamper recovery circuitry 322 can determine, based on user and/or manufacturer preferences, that the standby mode can be exited after a random amount of delay after a standby indicator has been obtained. A standby indicator may be a signal from the processing circuitry that standby mode has been implemented. After the clock loss detection tamper recovery circuitry 322 determines that standby mode can be exited, the clock loss detection tamper recovery circuitry 322 outputs a signal to the tamper recover aggregation circuitry 330.

The third recovery circuitry 311 of FIG. 3 facilitates the recovery from standby mode by determining whether to exit standby mode with respect to a temperature sensor tamper. The input terminal 324 obtains a signal from the temperature event detection circuitry 204 of FIG. if there is no indication of a temperature tamper (e.g., during regular operation and/or after a temperature tamper ends). For example, the input terminal 324 can be coupled to the output terminal of one or more of temperature sensor detection circuitries 224, 226 of FIG. 2. If the outputs of the respective circuitries 218, 222 reflect that there is no temperature tamper, a TSENS (temperature tamper detection) good signal will be input into the temperature sensor tamper recovery circuitry 322. In this manner, the temperature sensor tamper recovery circuitry 322 can determine whether to exit standby mode based on a temperature tamper ending or not existing, as further described below.

The random time delay circuitry 326 of FIG. 3 generates a random, pseudo-random, quasi-random, and/or predefined delay based on a signal from the temperature sensor tamper recovery circuitry 322. As further described below, the temperature sensor tamper recovery circuitry 322 can use the random time delay to wait before outputting a signal to indicate that standby mode can be exited to provide additional security from an attacker. The random time delay circuitry 326 is further described below in conjunction with FIGS. 5 and/or 6.

The temperature sensor detection tamper recovery circuitry 328 of FIG. 3 determines whether to indicate that standby mode can be exited with respect to temperature tamper monitoring. For example, the temperature sensor detection tamper recovery circuitry 328 can determine, based on user and/or manufacturer preferences, that standby mode can be exited after a random amount of delay after determining that there is no or no longer a temperature tamper. Also, the temperature sensor detection tamper recovery circuitry 328 can determine, based on user and/or manufacturer preferences, that the standby mode can be exited after a random amount of delay after a standby indicator has been obtained. A standby indicator may be a signal from the processing circuitry that standby mode has been implemented. After the temperature sensor detection tamper recovery circuitry 328 determines that standby mode can be exited, the temperature sensor detection tamper recovery circuitry 328 outputs a signal to the tamper recover aggregation circuitry 330. Each tamper recovery circuitry 316, 322, 328 can individually be structured by a user to indicate a readiness to exit standby mode based on a standby indicator and/or based on a tamper/glitch good signal.

The tamper recovery aggregation circuitry 330 of FIG. 3 aggregates the multiple outputs of the recovery circuitries 308, 310, 311 of FIG. 3 to determine whether the respective tamper recovery circuitries 308, 310, 311 are ready to exit standby mode. In some examples, the tamper recovery aggregation circuitry 330 may also include inputs for additional tamper event recovery circuitries (e.g., an electromagnetic event, a laser event, etc.). In some examples, the tamper recovery aggregation circuitry 330 includes and/or operates as a logic AND gate. For example, if any one of the inputs correspond to a voltage that represents not ready to recover from standby mode, the tamper recovery aggregation circuitry 330 outputs a first voltage (e.g., a low voltage or 0 V) to indicate that the tamper condition is still present. However, if all of the inputs correspond to a voltage that represents ready to recover from standby mode, the tamper event aggregator outputs a second (e.g., high) voltage to trigger (a) the security controller 304 to reset the firewall settings to pre-tamper settings and (b) the power management controller 306 to trigger the processing circuitry to exit standby mode. Thus, normal operation can return after a tamper event to continue operation.

FIG. 4 is a block diagram of an example implementation of the response and recovery circuitry 114 or 116 of FIG. 1. The example response and recovery circuitry 114, 116 of FIG. 4 includes the example tamper detection response circuitry 302, the example security controller 304, the example power management controller 306 and the example tamper recovery aggregation circuitry 330 of FIG. 3. The example response and recovery circuitry 114, 116 of FIG. 4 further includes example tamper event aggregation circuitry 400 and example tamper event recovery circuitries 402, 404, 406. The first recovery circuitry 402 includes the example input terminal 312 and the example random time delay circuitry 314 of FIG. 3 and example voltage glitch tamper recovery circuitry 408. The second recovery circuitry 404 includes the example input terminal 318 and the example random time delay circuitry 320 of FIG. 3 and example clock tamper event recovery circuitry 410. The third recovery circuitry 406 includes the example input terminal 324 and the example random time delay circuitry 326 of FIG. 3 and example temperature tamper event recovery circuitry 412.

The tamper event aggregation circuitry 400 of FIG. 4 operates in a similar manner to the tamper event aggregation circuitry 300 of FIG. 3. However, the tamper event aggregation circuitry 400 includes an additional input (e.g., the IO event terminal) that is coupled to the output of the tamper event aggregation circuitry 300 in the response and recovery circuitry 110 of FIG. 3. Accordingly, the tamper event aggregation circuitry 400 can output an IO event signal indicative of a tamper event based on a tamper event identified at the leader controller 102. In some examples, one or more of the inputs of the tamper event aggregation circuitry 400 may be removed or not needed if the corresponding tamper detection circuits are not included in the implementing SoC. For example, because the follower circuit 106 does not include any tamper detection circuitry, the other inputs may be removed or be not connected to anything (e.g., where tamper detection is purely based on a signal from the leader controller 102). As described above in conjunction with FIG. 3, if any of the inputs corresponds to a first voltage (e.g., a logic high voltage), the tamper event aggregator 400 outputs a tamper event signal that triggers a firewall adjustment and/or a standby mode. Thus, if the IO event signal from the leader controller 102 (e.g., corresponding to a tamper event detected by the leader controller 102) corresponds to a logic high voltage, the tamper event aggregator 400 will output a tamper event signal that triggers a firewall adjustment and/or a standby mode at the follower circuit.

Also, the tamper recovery circuitries 402, 404, 406 operate in a similar manner to the tamper recovery circuitries 308, 310, 311 of FIG. 3. However, the tamper recovery circuitries 402, 404, 406 include an additional input (e.g., an IO event terminal) coupled to the output of the tamper event aggregation circuitry 300 in the response and recovery circuitry 110 of FIG. 3 in the leader controller 102. Accordingly, the tamper recovery circuitries 402, 404, 406 can, based on user and/or manufacturer preferences, output a signal indicative of readiness to exit standby mode based on a trigger (e.g., the IO event signal) from the leader controller 102. For example, any one of the voltage glitch tamper recovery circuitry 408, the clock loss tamper circuitry 410, and/or the temperature sense tamper circuitry 412 can generate an output signal based on the IO event signal from the leader controller 102. Thus, recovery from the firewall adjustments and/or standby mode may be based on the IO event signal from the leader controller 102 of FIG. 1. As described above, the IO event signal corresponds to whether the leader controller 102 is identifying a tamper event.

Although the example of FIG. 4 includes three input terminals corresponding to different tamper detection circuitries, one or more of the input terminals could be removed/not connected to anything, and/or be connected to local tamper detection circuitry. For example, one or more of the input terminals 312, 318, 324 may be connected to output terminals of the partial tamper detection circuitry 112. Because the follower circuit 106 of FIG. 1 does not include tamper detection circuitry, the input terminals 312, 318, 324 can be removed or remain disconnected (e.g., recovery is based purely on the IO event signal from the leader controller 102).

FIG. 5 illustrates a block diagram of an example implementation of the first tamper recovery circuitry 308 of FIG. 3. The example first tamper recovery circuitry 308 includes the input terminal 312 and the random time delay circuitry 314 of FIG. 3. However, FIG. 5 can be used to describe the second or third tamper recovery circuitry 310, 311 of FIG. 3 by using the other input terminals 318, 324. The first tamper recovery circuitry 308 further includes an example multiplexer 500, an example random number generator 502, and an example counter 504.

The multiplexer (MUX) 500 of FIG. 5 includes two input terminals, a select terminal, and an output terminal. The first input terminal of the MUX 500 is coupled to the processing circuitry and/or the power management controller 306 of the leader controller 102 to obtain an indication that the processing circuitry has entered into the standby mode. The second input terminal of the MUX 500 is coupled to the input terminal 312 (e.g., corresponding to the output terminal of one or more of the voltage glitch detection circuitries 206, 210, 214 of FIG. 2). The select terminal of the MUX 500 obtains a user and/or manufacturer selected configuration. In this manner, the user and/or manufacturer can select whether to recover from standby mode in response to the processing unit of the leader controller 102 entering the standby mode or after the one or more voltage glitch circuitries determine that a voltage glitch is not occurring. For example, a user can apply a first voltage (e.g., a low voltage or 0 V) to the select terminal of the MUX 500 to trigger the MUX 500 to output the standby indicator from the processing circuitry an/or power management controller 306 indicative of whether standby mode is occurring. Also, the user can apply a second voltage (e.g., a high voltage or 1.3 V) to the select terminal of the MUX 500 to trigger the MUX 500 to output the VGD good signal indicative of whether a voltage glitch is stopped. The output of the MUX 500 corresponds to an enable signal that, after raising from a low voltage to a high voltage, causes the random number generation circuitry 502 to generate a random number.

After the enable signal goes high, the random number generator circuitry 502 of FIG. 5 generates a random number. The random number may be selected from a group of preselected numbers or may be any number within a range of numbers. As further described below, the random number is used to generate a random amount of delay before continuing operation after the enable signal goes high. The random number generator circuitry 502 outputs the generated number to the counter 504.

The counter 504 of FIG. 5 operates as a timer to generate an amount of delay based on the number generated by the random number generator circuitry 502. For example, the counter 504 obtains the number generated by the random number generator circuitry 502 and counts down from the number to a predefined value (e.g., 0) or up from a predefined number (e.g., 0) to the number. The counter 504 may use the clock signal from one of the clock oscillators 216, 220 to increment or decrement the count. After the count corresponding to the random number is complete, the counter 504 outputs a tamper release signal to the tamper recovery aggregator circuitry 330 to exit standby mode if the tamper recovery circuities output tamper release signals. In this manner, the power management controller 306 exits standby mode and continues operations at different times after disappearance of different tamper events, thereby creating randomization to confuse and/or avoid additional attacks from an attacker.

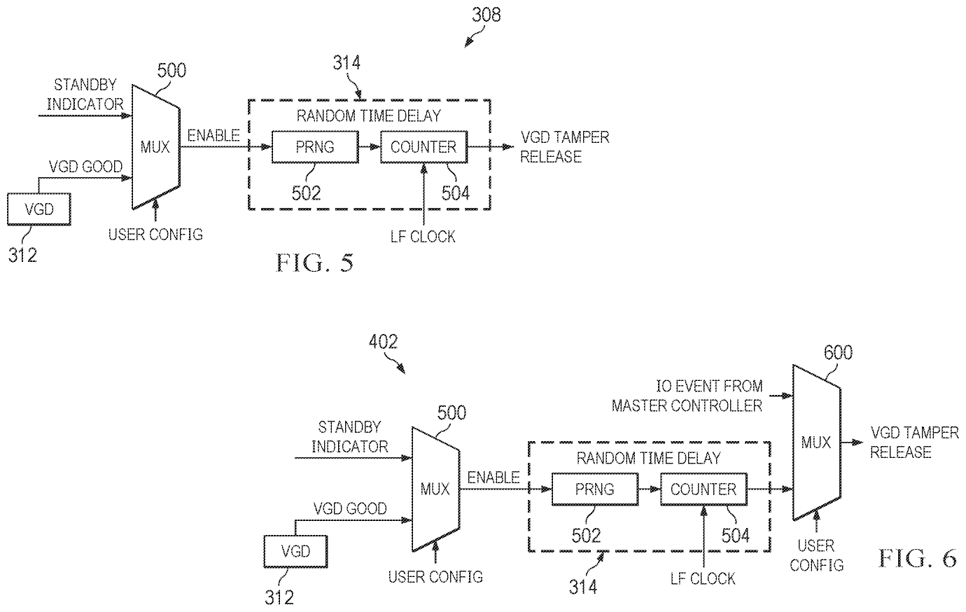

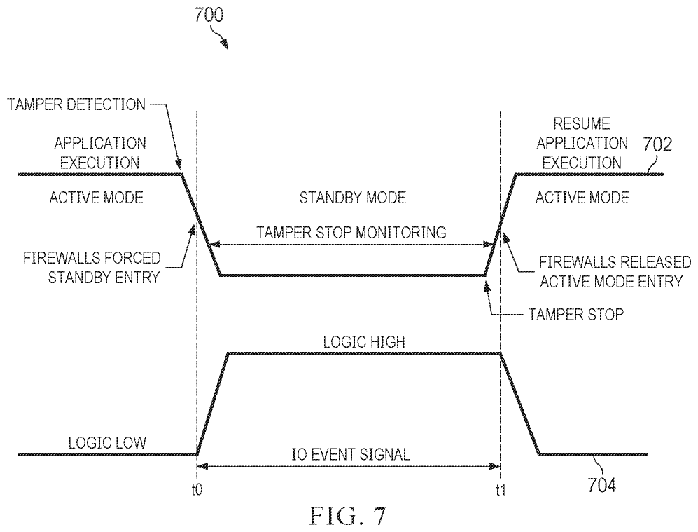

FIG. 6 illustrates a block diagram of an example implementation of the first tamper recovery circuitry 402 of FIG. 4. The example first tamper recovery circuitry 402 includes the input terminal 312 and the random time delay circuitry 314 of FIG. 3. However, FIG. 6 can be used to describe the second or third tamper recovery circuitry 310, 311 of FIG. 3 by using the other input terminal 318, 324. The first tamper recovery circuitry 402 further includes the example multiplexer 500, the example random number generator 502, and the example counter 504 of FIG. 5. Also, the first tamper recovery circuitry 402 includes a second example MUX 600.

The multiplexer (MUX) 600 of FIG. 6 includes two input terminals, a select terminal, and an output terminal. The first input terminal of the MUX 600 is coupled to the output terminal of the tamper event aggregation circuitry 300 in the response and recovery circuitry 110 of the leader controller 102. Thus, the MUX 600 is configured to receive an IO event signal from the leader controller 102 via the first input terminal of the MUX 600. The second input terminal of the MUX 600 is coupled to the output of the counter 504. The select terminal of the MUX 600 is configured to receive a user and/or manufacturer selected configuration. In this manner, the user and/or manufacturer can select whether to recover from standby mode in response different triggering events. The triggering events may include the processing unit of the leader controller 102 entering the standby mode, one or more voltage glitch circuitries determine that a voltage glitch is not occurring, or the IO event signal from the leader controller 102. For example, a user can apply a first voltage (e.g., a low voltage or 0 V) to the select terminal of the MUX 600 to trigger the MUX to output the IO event signal from the leader controller 102. This configuration may be automatically set for follower SoCs (e.g., the circuit 106) that do not have the corresponding tamper detection circuitry. Also, the user can apply a second voltage (e.g., a high voltage or 1.3 V) to the select terminal of the MUX 600 to trigger the MUX 600 to output the output of the counter 504. The output of the MUX 600 is a tamper release signal to the tamper recovery aggregator circuitry 330 to exit standby mode if the tamper recovery circuities output tamper release signals. In this manner, the power management controller 306 will exit standby mode and continue operations at different times after disappearance of different voltage glitches, thereby creating randomization to confuse and/or avoid additional attacks from an attacker.

As described above, the MUX 600 may be configured to output a tamper release signal in response to an IO event signal received from the leader controller 102. In some examples, the IO event signal can be referred to as an all-clear signal because the leader controller 102 may send this signal to the follower circuit to indicate that the follower circuit should exit standby mode. For example, for the follower circuit 106, where there is no tamper detection circuit, the IO event signal is the only signal that is used to exit standby mode and/or recover from the firewall adjustment. Thus, the IO event signal is an all-clear signal to recover from standby mode and/or adjust the firewall. In some examples, the MUX 600 for one tamper event recovery circuitry may be based on the IO event signal from the leader controller 102 while the MUX for another tamper event recovery circuitry may be based on signal(s) from the partial tamper detection circuitry 112. In such examples, the IO event signal can be used to indicate that a first particular tamper event is over while the partial tamper detection circuitry 112 indicates whether a second particular tamper event is over and the tamper recovery aggregator 330 recovers from the standby mode and/or firewall configurations after both indications are obtained.

FIG. 7 is an example timing diagram 700 that illustrates an output voltage from one or more of the full tamper detection circuitry 108 and/or the partial tamper detection circuitry 112 in response to a detected tamper. The timing diagram 700 includes a tamper plot 702 and an IO event signal plot 704.

As shown in the example tamper plot 702, before time t0, the monitored voltage, temperature, clock signal, etc. is at an appropriate working level. However, after time t0, the tamper plot 702 begins to drop below a threshold. Thus, one or more of the tamper detection circuitries 108, 112 will output a signal (e.g., a tamper event alert) to the response recovery circuitry 110, 114. After the response and recovery circuitry 110, 114 determines that a tamper event is occurring, the response and recovery circuitry 110, 114 will cause the corresponding device to enter into a standby mode and/or adjust the firewall settings to prevent access to one or more components of the circuit 100. Between times t0 and t1, the leader controller 102 and/or the follower circuit(s) 104, 106 will remain in standby mode until the tamper recovery aggregator 300 determines that it is ok to return to normal execution, as described above in conjunction with FIGS. 3-6. After time t1, normal execution continues by exiting standby mode and/or returning to the previous firewall settings. In some examples, the normal execution returns after a random duration of time after time t1, as further described above.

The example IO event signal plot 704 illustrates the IO event signal that is generated by the leader controller 102 in response to a tamper event. At time t0, because a tamper event has not been detected, the IO event signal plot 704 is a logic low voltage (e.g., 0 V). After time t0, after the tamper event is detected, the leader controller 102 increases the IO event signal from the logic low voltage to a logic high voltage (e.g., 3 V). As described above, the IO event signal being a logic high causes one or more of the follower circuits 104, 106 to enter into standby mode and/or adjust the firewall settings of the corresponding follower circuit 104, 106. Thus, the logic transition at time t0 can act as a trigger to cause the follower circuit 104, 106 to respond to a tamper event. As described above, the leader controller 102 can control whether the follower circuit(s) 104, 106 enter and/or exit standby mode/firewall restriction because the follower circuits(s) 104, 106 may not have the capability to identify tamper events. Also, a user may prefer that the leader controller 102 control the follower circuits 104, 106 based on tamper events, regardless of whether follower circuitry 104, 106 are capable of detecting such tamper events.

Between time t0 and t1, because the IO event signal plot 704 corresponds to a logic high, the corresponding follower circuit(s) 104, 106 will remain in standby mode and/or in a firewall restrictive mode. After time t1, the leader controller 102 will determine that the tamper event has ended and will return the IO event signal to a logic low signal. The logic transition at time t1 can act as an all-clear signal to notify the follower circuit 104, 106 that the tamper event has ended. Thus, after the follower circuit(s) 104, 106 obtain the logic low signal on the IO event terminal, the follower circuit(s) 104, 106 will resume normal application operation by exiting from standby mode and recovering from the firewall adjustments.

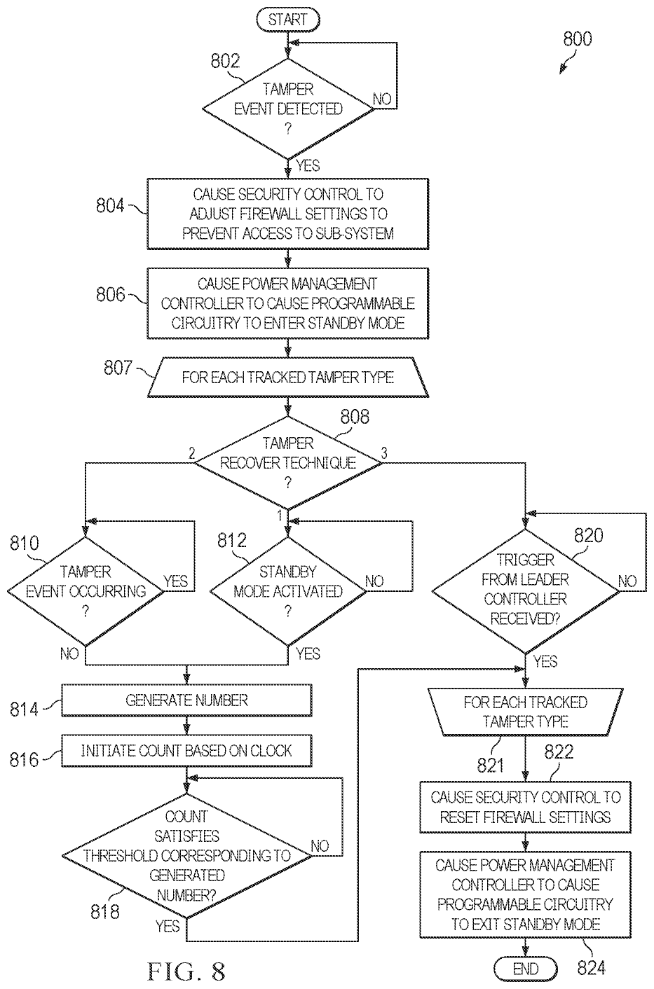

FIG. 8 is a flowchart representative of a method and/or example operations 800 that may be executed and/or instantiated by processing circuitry or any other circuitry of any one of the response and recovery circuitry 110, 114, 116 of FIGS. 1-6 to protect against a tamper event. The operations 800 can be performed by any one or combination of the circuitry shown in FIGS. 1-6. Although the instructions and/or operations of FIG. 8 are described in conjunction with the circuit 100 of FIGS. 1, the instructions and/or operations may be described in conjunction with any type of circuit that implements processing circuitry. Some processes shown in FIG. 8 may be performed in orders other than described, and many processes may be performed concurrently in parallel. Furthermore, processes shown in FIG. 8 may be omitted or substituted in some examples of the present description.

The machine-readable instructions and/or the operations 800 of FIG. 8 begin at block 802, at which the tamper event aggregation circuitry 300, 400 determines if a tamper event has been detected. For example, the tamper event aggregation circuitry 300 determines if a tamper event has been detected based on one or more output signals from one or more circuits of the full tamper detection circuitry 108. The tamper event aggregation circuitry 400 determines if a tamper event is occurring based on one or more output signals from one or more circuits of the partial tamper detection circuitry 112 and/or based on a tamper event signal (e.g., the IO event signal shown in FIGS. 3, 4, and 6) from the response and recovery circuitry 110 of the leader controller 102. If the tamper event aggregation circuitry 300, 400 determines that a tamper event has not been detected (block 802: NO), control returns to block 802 until a tamper event is detected. If the tamper event aggregation circuitry 300, 400 determines that a tamper event has been detected (block 802: YES), control continues to block 804.

At block 804, the example tamper detection response circuitry 302 causes the security controller 304 to adjust the firewall settings to prevent access to sub-system (e.g., a debug sub-system, an accelerator, memory, etc.). At block 806, the tamper detection response circuitry 302 causes the power management controller 306 to trigger the processing circuitry to enter a standby mode. For each tracked tamper type (e.g., voltage glitch, clock loss, temperature, etc.) (blocks 807-721), the tamper recovery circuitry 316, 322, 328, 408, 410, 412 determines which tamper recovery technique to utilize (block 808). As further described above, the tamper recovery technique is based on user and/or manufacturer preferences and can be determined based on the select input(s) of the MUXs, 500, 600 of FIGS. 5 and/or 6. In some examples (e.g., for follower SoCs that do not have corresponding tamper detection circuitry), the tamper recovery technique may be auto set to the third technique. Also, the tamper recovery circuitry 316, 322, 328 of the leader controller 102 may be restricted from selecting the third tamper recover technique because it is not influenced by another leader controller.

If the tamper recovery circuitry 316, 322, 328, 408, 410, 412 selects the first tamper recover technique (block 808: 1) control continues to block 812. If the tamper recovery circuitry 316, 322, 328, 408, 410, 412 selects the second tamper recover technique (block 808: 2) control continues to block 810. If the tamper recovery circuitry 316, 322, 328, 408, 410, 412 selects the third tamper recover technique (block 808: 3) control continues to block 820. At block 820, the random number generation circuitry 502 determines if an IO event signal from the leader controller 102 corresponds to a tamper event detected by the leader controller 102. For example, if the third tamper recover technique is selected, the MUX 600 (FIG.) outputs the IO event signal from the leader controller 102. Thus, if the leader controller 102 all output a low voltage for the IO event signal indicative of no voltage glitch, the tamper event recovery circuitry 402 outputs a signal to the tamper recover aggregator 330 to indicate that there is no more voltage glitch and firewall and/or standby recovery can occur with respect to a voltage glitch.

If the random number generation circuitry 502 determines that there is a tamper event occurring for a particular tamper type (block 810: YES), control returns to block 810 until the tamper event has ended. If the random number generation circuitry 502 determines that a tamper event is not occurring for a particular tamper type (block 810: NO), control continues to block 814 as further described below. At block 812, the random number generation circuitry 502 determines if standby mode has been entered. For example, if the second tamper recover technique is selected, the MUX 500 (FIGS. 5 and/or 6) outputs the signal from the power management controller 306 and/or the processing circuitry to indicate that standby mode has been entered. Thus, the random number generator circuitry 502 can determine that standby mode has been entered based on the standby mode indication signal from the MUX 500, 600. If the random number generation circuitry 502 determines that standby mode has not yet been activated (block 812: NO), control returns to block 812 until standby mode is activated. If the random number generation circuitry 502 determines that standby mode has been activated (block 812: YES), control continues to block 814.

At block 814, the random number generation circuitry 502 generates a number (e.g., a random number, a pseudo- or quasi-random number, a selection of a list of predefined numbers, etc.). At block 816, the example counter 504 initiates (e.g., increments from zero or decrements from the generated number) a count based on a clock signal. The circuitry may be configured to initiate the counter 504 based on the detection of a tamper event, the determination that the tamper event has ended, and/or the processor entering standby mode. At block 818, the counter 504 determines whether the count satisfies a threshold corresponding to the generated number. For example, if the counter 504 is incrementing counts based on a clock signal starting from zero, the counter 504 determines if the count has reached the generated number. If the counter 504 is decrementing a count from the generated number, the counter determines if the count has reached zero.

If the counter 504 determines that the count does not satisfy the threshold corresponding to the generated number (block 818: NO), control continues to block 818 while the counter 504 continues to adjust the count based on the clock signal until the count is satisfied. If the counter 504 determines that the count satisfies the threshold corresponding to the generated number (block 818: YES), control continues to block 821.

At block 822, after all of the tamper recovery circuitry(ies) 316, 322, 328, 408, 410, 412 output a tamper release signal indicative of a return from standby mode, the tamper recovery aggregation circuitry 300 causes the security controller 304 to reset the firewall settings back to the settings before standby mode was entered. At block 824, the tamper recovery aggregation circuitry 300 causes the power management controller 306 to trigger the programmable circuitry to exit the standby mode and continue operation.

An example manner of implementing the circuit 100 of FIG. 1 is illustrated in FIGS. 1-6. However, one or more of the elements, processes and/or devices illustrated in FIGS. 1-6 may be combined, divided, re-arranged, omitted, eliminated and/or implemented in any other way.

Further, the full tamper detection circuitry 108, the response and recovery circuitry 110, 114, 116, the partial tamper detection circuitry 112, the glitch detection circuitries 206, 210, 214, the clock loss detection circuitries 218, 222, the temperature sensors 224, 226, the tamper event aggregation circuitries 300, 400, the tamper detection response block circuitries 302, the security controller 304, the power management controller 306, the random time delay circuitries 314, 320, 326, the tamper recovery circuitries 316, 322, 328, 408, 410, 412, the tamper recover aggregation circuitry 330, the MUXs 500, 600, the random number generation circuitry 502, and/or the counter circuitry 504 of FIGS. 1-6 may be implemented by hardware, software, firmware and/or any combination of hardware, software and/or firmware. As a result, for example, any of the full tamper detection circuitry 108, the response and recovery circuitry 110, 114, 116, the partial tamper detection circuitry 112, the glitch detection circuitries 206, 210, 214, the clock loss detection circuitries 218, 222, the temperature sensors 224, 226, the tamper event aggregation circuitries 300, 400, the tamper detection response block circuitries 302, the security controller 304, the power management controller 306, the random time delay circuitries 314, 320, 326, the tamper recovery circuitries 316, 322, 328, 408, 410, 412, the tamper recover aggregation circuitry 330, the MUXs 500, 600, the random number generation circuitry 502, and/or the counter circuitry 504 of FIGS. 1-6 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

When reading any of the apparatus or system claims of this patent to cover a purely software and/or firmware implementation, at least one of the full tamper detection circuitry 108, the response and recovery circuitry 110, 114, 116, the partial tamper detection circuitry 112, the glitch detection circuitries 206, 210, 214, the clock loss detection circuitries 218, 222, the temperature sensors 224, 226, the tamper event aggregation circuitries 300, 400, the tamper detection response block circuitries 302, the security controller 304, the power management controller 206, the random time delay circuitries 314, 320, 326, the tamper recovery circuitries 316, 322, 328, 408, 410, 412, the tamper recover aggregation circuitry 330, the MUXs 500, 600, the random number generation circuitry 502, and/or the counter circuitry 504 of FIGS. 1-6 is/are hereby expressly defined to include a non-transitory computer readable storage device or storage disk such as a memory, a digital versatile disk (DVD), a compact disk (CD), a Blu-ray disk, etc., including the software and/or firmware. Further still, the full tamper detection circuitry 108, the response and recovery circuitry 110, 114, 116, the partial tamper detection circuitry 112, the glitch detection circuitries 206, 210, 214, the clock loss detection circuitries 218, 222, the temperature sensors 224, 226, the tamper event aggregation circuitries 300, 400, the tamper detection response block circuitries 302, the security controller 304, the power management controller 206, the random time delay circuitries 314, 320, 326, the tamper recovery circuitries 316, 322, 328, 408, 410, 412, the tamper recover aggregation circuitry 330, the MUXs 500, 600, the random number generation circuitry 502, and/or the counter circuitry 504 of FIGS. 1-6 may include one or more elements, processes and/or devices in addition to, or instead of, those illustrated in FIGS. 1-6, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

Flowcharts representative of example hardware logic, machine-readable instructions, hardware implemented state machines, and/or any combination thereof for implementing the circuit 100 of FIGS. 1-6 are shown in FIG. 8. The machine-readable instructions may be one or more executable programs or portion(s) of an executable program for execution by a computer processor. The program may be embodied in software stored on a non-transitory computer readable storage medium such as a CD-ROM, a floppy disk, a hard drive, a DVD, a Blu-ray disk, or a memory associated with the processor, but the entire program and/or parts thereof could alternatively be executed by a device other than the processor and/or embodied in firmware or dedicated hardware.

Further, although the example program is described with reference to the flowcharts illustrated in FIG. 8, many other methods of implementing the circuit 100 may alternatively be used. For example, the order of execution of the blocks may be changed, and/or some of the blocks described may be changed, eliminated, or combined. Also or alternatively, any or all of the blocks may be implemented by one or more hardware circuits (e.g., discrete and/or integrated analog and/or digital circuitry, a field-programmable gate array (FPGA), an application-specific integrated circuit (ASIC), a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine-readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, in which the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. As a result, the described machine-readable instructions and/or corresponding program(s) encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example processes of FIG. 8 may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein when identifying multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for ease of understanding the described examples. In some examples, the descriptor “first” may be used to refer to an element in the detailed description, while the same element may be referred to in a claim with a different descriptor such as “second” or “third.” In such instances, such descriptors are used merely for ease of referencing multiple elements or components.

In the description and in the claims, the terms “including” and “having” and variants thereof are to be inclusive in a manner similar to the term “comprising” unless otherwise noted. Unless otherwise stated, “about,” “approximately,” or “substantially” preceding a value means+/−10 percent of the stated value. In another example, “about,” “approximately,” or “substantially” preceding a value means+/−5 percent of the stated value. IN another example, “about,” “approximately,” or “substantially” preceding a value means +/−1 percent of the stated value.

The term “couple” “coupled”, “couples”, and variants thereof, as used herein, may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A. Moreover, the terms “couple”, “coupled”, “couples”, or variants thereof, includes an indirect or direct electrical or mechanical connection.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Although not all separately labeled in the FIGS. 1-6, components or elements of systems and circuits illustrated therein have one or more conductors or terminus that allow signals into and/or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically and/or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on a particular circuit or system topology, there may be more or fewer terminals and nodes. However, in some instances, “terminal”, “node”, “interconnect”, “pad”, and “pin” may be used interchangeably.

Example methods, apparatus, systems, and articles of manufacture to protect against tamper events are described herein. Further examples and combinations thereof include the following: Example 1 is an apparatus comprising tamper detection response circuitry operable to, in response to a detected tamper event, cause a programmable circuitry to enter standby mode, number generator circuitry operable to generate a number, and tamper recovery aggregation circuitry operable to trigger the programmable circuitry to exit the standby mode after a threshold amount of time based on the generated number.

Example 2 includes the apparatus of example 1, further including first tamper event aggregation circuitry operable to detect the tamper event based on a second signal from second tamper event aggregation circuitry, wherein the tamper detection response circuitry is implemented in the apparatus and the second tamper event aggregation circuitry is implemented by a leader controller.

Example 3 includes the apparatus of example 2, wherein the apparatus is a system on chip separate from the leader controller.

Example 4 includes the apparatus of example 1, further including a counter operable to increment a count to determine whether the number satisfies a threshold corresponding to the threshold amount of time.

Example 5 includes the apparatus of example 4, wherein the counter is operable to initiate the count after the programmable circuitry enters the standby mode.

Example 6 includes the apparatus of example 4, wherein the counter is operable to initiate the count after the tamper event has ceased.

Example 7 includes the apparatus of example 1, wherein the tamper detection response circuitry is operable to, in response to the detected tamper event, cause adjustment of firewall settings to prevent access to a sub-system.

Example 8 includes the apparatus of example 7, wherein the sub-system includes at least one of an accelerator, debug circuitry, or memory, and wherein the sub-system is part of the apparatus.

Example 9 includes the apparatus of example 1, wherein the tamper event corresponds to at least one of a temperature adjustment, a clock loss, an electromagnetic event, or laser-based event.

Example 10 includes an apparatus comprising tamper detection response circuitry operable to, in response to a detected tamper event, cause adjustment of firewall settings to prevent access to a sub-system, number generator circuitry operable to generate a number, and tamper recovery aggregation circuitry operable to reset the firewall settings to allow access to the sub-system after a threshold amount of time, the threshold amount of time corresponding to the generated number.

Example 11 includes the apparatus of example 10, further including first tamper event aggregation circuitry operable to detect the tamper event based on a second signal from second tamper event aggregation circuitry, wherein the tamper detection response circuitry is implemented by a system on chip and the second tamper event aggregation circuitry is implemented by a leader controller.

Example 12 includes the apparatus of example 10, further including a counter operable to increment a count to determine whether the number satisfies a threshold corresponding to the threshold amount of time.

Example 13 includes the apparatus of example 12, wherein the counter is operable to initiate the count after the adjustment of the firewall settings.

Example 14 includes the apparatus of example 12, wherein the counter is operable to initiate the count after the tamper event has ceased.

Example 15 includes the apparatus of example 10, wherein the tamper detection response circuitry is operable to, in response to the detected tamper event, cause a programmable circuitry to enter standby mode.

Example 16 includes the apparatus of example 10, wherein the sub-system includes at least one of an accelerator, debug circuitry, or memory, and wherein the sub-system is part of the apparatus.

Example 17 includes the apparatus of example 10, wherein the tamper event corresponds to at least one of a voltage glitch, a temperature adjustment, a clock loss, an electromagnetic event, or laser-based event.

Example 18 includes a system comprising a leader controller to, after detection of a tamper event output an indication of the tamper event, and enter a standby mode, and follower circuitry to, after obtaining the indication of the tamper event from the leader controller, enter a standby mode.

Example 19 includes the system of example 18, wherein the leader controller is to, after the tamper event ends, output an indication of an end of the tamper event, and the follower circuitry is to, after obtaining the indication of the end of the tamper event from the leader controller, exit the standby mode.

Example 20 includes the system of example 19, wherein the follower circuitry is to exit the standby mode after obtaining the indication of the end of the tamper event from the leader controller and after obtaining an indication from a locally implemented tamper detection circuit.

Modifications are possible in the described embodiments, and other embodiments are possible, within the scope of the claims.

What is claimed is:

1. An apparatus comprising:
tamper detection response circuitry operable to, in response to a detected tamper event, cause a programmable circuitry to enter standby mode;
number generator circuitry operable to generate a number; and
tamper recovery aggregation circuitry operable to trigger the programmable circuitry to exit the standby mode after a threshold amount of time based on the generated number.

2. The apparatus of claim 1, further including first tamper event aggregation circuitry operable to detect the tamper event based on a second signal from second tamper event aggregation circuitry, wherein the tamper detection response circuitry is implemented in the apparatus and the second tamper event aggregation circuitry is implemented by a leader controller.

3. The apparatus of claim 2, wherein the apparatus is a system on chip separate from the leader controller.

4. The apparatus of claim 1, further including a counter operable to increment a count to determine whether the number satisfies a threshold corresponding to the threshold amount of time.

5. The apparatus of claim 4, wherein the counter is operable to initiate the count after the programmable circuitry enters the standby mode.

6. The apparatus of claim 4, wherein the counter is operable to initiate the count after the tamper event has ceased.

7. The apparatus of claim 1, wherein the tamper detection response circuitry is operable to, in response to the detected tamper event, cause adjustment of firewall settings to prevent access to a sub-system.

8. The apparatus of claim 7, wherein the sub-system includes at least one of an accelerator, debug circuitry, or memory, and wherein the sub-system is part of the apparatus.

9. The apparatus of claim 1, wherein the tamper event corresponds to at least one of a temperature adjustment, a clock loss, an electromagnetic event, or laser-based event.

10. An apparatus comprising:
tamper detection response circuitry operable to, in response to a detected tamper event, cause adjustment of firewall settings to prevent access to a sub-system;
number generator circuitry operable to generate a number; and
tamper recovery aggregation circuitry operable to reset the firewall settings to allow access to the sub-system after a threshold amount of time, the threshold amount of time corresponding to the generated number.

11. The apparatus of claim 10, further including first tamper event aggregation circuitry operable to detect the tamper event based on a second signal from second tamper event aggregation circuitry, wherein the tamper detection response circuitry is implemented by a system on chip and the second tamper event aggregation circuitry is implemented by a leader controller.

12. The apparatus of claim 10, further including a counter operable to increment a count to determine whether the number satisfies a threshold corresponding to the threshold amount of time.

13. The apparatus of claim 12, wherein the counter is operable to initiate the count after the adjustment of the firewall settings.

14. The apparatus of claim 12, wherein the counter is operable to initiate the count after the tamper event has ceased.

15. The apparatus of claim 10, wherein the tamper detection response circuitry is operable to, in response to the detected tamper event, cause a programmable circuitry to enter standby mode.

16. The apparatus of claim 10, wherein the sub-system includes at least one of an accelerator, debug circuitry, or memory, and wherein the sub-system is part of the apparatus.

17. The apparatus of claim 10, wherein the tamper event corresponds to at least one of a voltage glitch, a temperature adjustment, a clock loss, an electromagnetic event, or laser-based event.

18. A system comprising:
a leader controller to, after detection of a tamper event:
output an indication of the tamper event; and
enter a standby mode; and
follower circuitry to, after obtaining the indication of the tamper event from the leader controller, enter a standby mode.

19. The system of claim 18, wherein:
the leader controller is to, after the tamper event ends, output an indication of an end of the tamper event; and
the follower circuitry is to, after obtaining the indication of the end of the tamper event from the leader controller, exit the standby mode.

20. The system of claim 19, wherein the follower circuitry is to exit the standby mode after obtaining the indication of the end of the tamper event from the leader controller and after obtaining an indication from a locally implemented tamper detection circuit.
